(19) United States
(12) Patent Application Publication
(10) Pub. No.: US 2024/0331407 A1
(43) Pub. Date: Oct. 3, 2024

(54) OWN-VEHICLE POSITION ESTIMATION DEVICE, VEHICLE CONTROL SYSTEM, AND OWN-VEHICLE POSITION ESTIMATION METHOD

(71) Applicant: Mitsubishi Electric Corporation, Tokyo (JP)

(72) Inventors: Takumi SATO, Tokyo (JP); Takefumi HASEGAWA, Tokyo (JP); Takafumi KASUGA, Tokyo (JP)

(73) Assignee: Mitsubishi Electric Corporation, Tokyo (JP)

(21) Appl. No.: 18/585,394

(22) Filed: Feb. 23, 2024

(30) Foreign Application Priority Data
Mar. 28, 2023 (JP) 2023-050933

(51) Int. Cl. G06V 20/56; G01C 21/34; G06T 7/13; G06T 7/70

(52) U.S. Cl. CPC G06V 20/588; G01C 21/34; G06T 7/13; G06T 7/70

(57) ABSTRACT

An own-vehicle position estimation device of the present disclosure comprises a first road lane division line information acquisition unit to acquire first road lane division line information including first left-side road lane division line information and first right-side road lane division line information, a second road lane division line information acquisition unit to acquire second road lane division line information including second left-side road lane division line information and second right-side road lane division line information based on map information, a road lane division line information determination unit to determine a combination of road lane division line information on the basis of the first road lane division line information and the second road lane division line information, and an own-vehicle position estimation unit to estimate the own-vehicle position by correcting the second road lane division line information using the combination of the road lane division line information.

### BACKGROUND

The present application relates to an own-vehicle position estimation device, a vehicle control system, and an own-vehicle position estimation method.

In recent years, for the purpose of implementing automatic traveling of a vehicle, there has been developed a technique of estimating a position of an own-vehicle on a map with high accuracy by using road lane division line information acquired by a sensor such as a camera mounted on the vehicle and road lane division line information based on a high-accuracy map.

However, the recognition of the road lane division line by the camera has a problem in that the road lane division line cannot be recognized with accuracy necessary for autonomous driving due to disappearance of a white line, blurring of the white line, omission of the white line, or the like on the road. In addition, due to problems on the camera side, such as dirt on the lens of the camera, flare, and occlusion, the road lane division line may not be recognized with accuracy required for autonomous driving, or an object that is not a road lane division line may be erroneously recognized as a road lane division line. That is, in the above-described own-vehicle position estimation technique, there is a problem in that an own-vehicle position cannot be correctly estimated when the road lane division line is erroneously recognized by the camera.
Patent Document 1: Japanese Patent Publication No. 7184951

The vehicle control device and vehicle control method described in Patent Document 1 discloses a vehicle control technique that includes a determination unit to determine whether or not either in one or the other in road lane division line information is misrecognized by comparing two road lane division lines obtained by two different means.

The vehicle control device and the vehicle control method described in Patent Document 1 discloses a method of performing error recognition determination about a recognition result of a road lane division line. However, no consideration has been given to a configuration and a method that allow the vehicle control processing to continue when an erroneous recognition of the road lane division line occurs.

### SUMMARY

The present disclosure has been made to solve the above-described problems, and an object of the present disclosure is to provide an own-vehicle position estimation device, a vehicle control system, and an own-vehicle position estimation method capable of continuously performing highly accurate own-vehicle position estimation by dynamically changing a combination of the road lane division line information to be used for estimating an own-vehicle position so as to be optimal information.

An own-vehicle position estimation device disclosed in the present application for estimating an own-vehicle position of a vehicle traveling on a road defined by a left-side road lane division line and a right-side road lane division line includes a first road lane division line information acquisition unit to acquire first road lane division line information including first left-side road lane division line information indicating a left-side road lane division line and first right-side road lane division line information indicating a right-side road lane division line, the first left-side road lane division line and the first right-side road lane division line being detected by an imaging device mounted on the vehicle, a second road lane division line information acquisition unit to acquire second road lane division line information including second left-side road lane division line information indicating the left-side road lane division line and second right-side road lane division line information indicating the right-side road lane division line, the second left-side road lane division line and the second right-side road lane division line being acquired by a method different from the detection method by the imaging device, a road lane division line information determination unit to determine a combination of road lane division line information to be used for estimating the own-vehicle position the a basis of the first road lane division line information and the second road lane division line information, and an own-vehicle position estimation unit to estimate the own-vehicle position by correcting the second road lane division line information using the combination of the road lane division line information determined by the road lane division line information determination unit.

A vehicle control system disclosed in the present application includes the own-vehicle position estimation device to estimate an own-vehicle position on the basis of road lane division line information, a traveling route generation device to generate a traveling route for the vehicle that reaches up to a target point on the basis of the own-vehicle position, using the own-vehicle position output from the own-vehicle position estimation device, and a vehicle control device to set a target trajectory and a target speed to be used for performing vehicle control of the vehicle on the generated traveling route.

An own-vehicle position estimation method disclosed in the present application for estimating an own-vehicle position of a vehicle traveling on a road defined by a left-side road lane division line and a right-side road lane division line using an own-vehicle position estimation device includes steps of acquiring first road lane division line information including first left-side road lane division line information indicating a left-side road lane division line and first right-side road lane division line information indicating a right-side road lane division line, the first left-side road lane division line and the first right-side road lane division line being detected by an imaging device mounted on the vehicle, acquiring second road lane division line information including second left-side road lane division line information indicating the left-side road lane division line and second right-side road lane division line information indicating the right-side road lane division line, the second left-side road lane division line and the second right-side road lane division line being acquired by a method different from the detection method by the imaging device, determining a combination of road lane division line information to be used for estimating the own-vehicle position on the basis of the first road lane division line information and the second road lane division line information, and estimating the own-vehicle position by correcting the second road lane division line information using the determined combination of the road lane division line information.

According to the own-vehicle position estimation device, the vehicle control system, and the own-vehicle position estimation method disclosed in the present application, a combination of the road lane division line information to be used for estimating the own-vehicle position is dynamically changed so as to be optimal information, bringing about an effect that a highly accurate own-vehicle position estimation can be continuously performed.

### BRIEF DESCRIPTION OF THE DRAWINGS

FIG. 1 is a block diagram showing a configuration of an own-vehicle position estimation device according to Embodiment 1;

FIG. 2 is a schematic diagram of a vehicle equipped with the own-vehicle position estimation device according to Embodiment 1;

FIG. 3 is a schematic diagram showing a situation in which a vehicle equipped with the own-vehicle position estimation device according to Embodiment 1 is traveling in a driving lane;

FIG. 4 is a schematic diagram for describing an operation of a first road lane division line information acquisition unit that is a part of the configuration of the own-vehicle position estimation device according to Embodiment 1;

FIG. 5 is a schematic diagram for describing an operation of the own-vehicle position estimation device according to Embodiment 1;

FIG. 6 is a schematic diagram for describing the operation of the own-vehicle position estimation device according to Embodiment 1;

FIG. 7 is a schematic diagram for describing the operation of the own-vehicle position estimation device according to Embodiment 1;

FIG. 8 is a schematic diagram for describing the operation of the own-vehicle position estimation device according to Embodiment 1;

FIG. 9 is a schematic diagram for describing the operation of the own-vehicle position estimation device according to Embodiment 1;

FIG. 10 is a flowchart for describing an own-vehicle position estimation method according to Embodiment 1;

FIG. 11 is a block diagram showing a configuration of an own-vehicle position estimation device according to Embodiment 2;

FIG. 12 is a schematic diagram for describing an operation of the own-vehicle position estimation device according to Embodiment 2;

FIG. 13 is a schematic diagram for describing the operation of the own-vehicle position estimation device according to Embodiment 2;

FIG. 14 is a schematic diagram for describing the operation of the own-vehicle position estimation device according to Embodiment 2;

FIG. 15 is a schematic diagram for describing the operation of the own-vehicle position estimation device according to Embodiment 2;

FIG. 16 is a flowchart for describing an own-vehicle position estimation method according to Embodiment 2;

FIG. 17 is a block diagram showing a configuration of a vehicle control system according to Embodiment 4;

FIG. 18 is a block diagram showing a hardware configuration for implementing the own-vehicle position estimation device according to Embodiment 1 and Embodiment 2 and the vehicle control system according to Embodiment 4;

FIG. 19 is a block diagram showing a hardware configuration for implementing the own-vehicle position estimation device according to Embodiment 1 and Embodiment 2 and the vehicle control system according to Embodiment 4.

### DETAILED DESCRIPTION OF THE EMBODIMENTS

### Embodiment 1

### <Configuration of Own-Vehicle Position Estimation Device According to Embodiment 1>

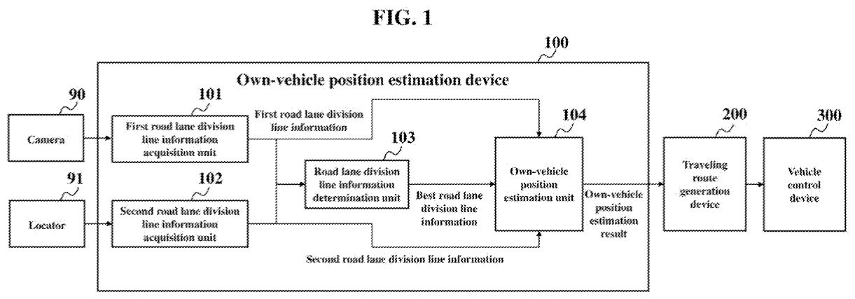

FIG. 1 is a block diagram showing a configuration of an own-vehicle position estimation device 100 according to Embodiment 1. The own-vehicle position estimation device 100 according to Embodiment 1 includes a first road lane division line information acquisition unit 101, a second road lane division line information acquisition unit 102, a road lane division line information determination unit 103, and an own-vehicle position estimation unit 104. The own-vehicle position estimation device 100 outputs an own-vehicle position estimation result to a traveling route generation device 200, and the traveling route generation device 200 outputs a traveling route generated on the basis of the own-vehicle position estimation result to a vehicle control device 300.

A camera 90 mounted on a vehicle 10 outputs an image obtained by capturing a situation of the road in front of the vehicle 10 to the first road lane division line information acquisition unit 101. Further, a locator 91 mounted on the vehicle 10 outputs acquired own-vehicle position information to the second road lane division line information acquisition unit 102.

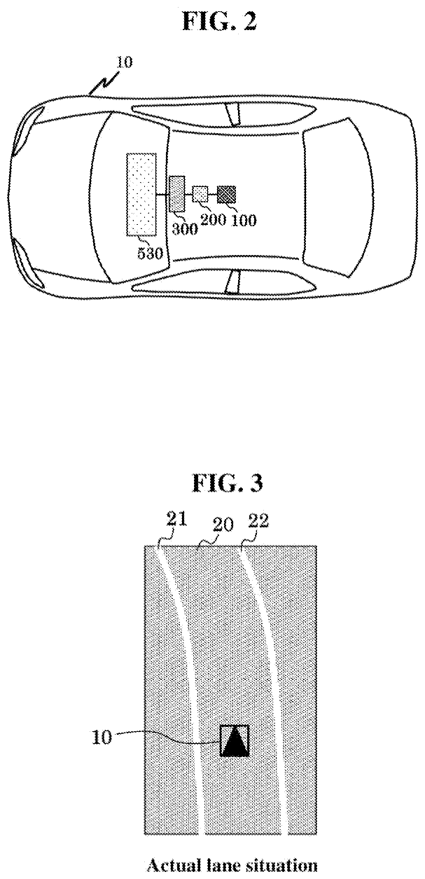

As shown in FIG. 2, the own-vehicle position estimation device 100, the traveling route generation device 200, and the vehicle control device 300 according to Embodiment 1 are incorporated in the vehicle 10. The traveling route generation device 200 generates a traveling route using the own-vehicle position estimation result output from the own-vehicle position estimation device 100, and the vehicle control device 300 generates target control amounts as a such target steering amount and target acceleration/deceleration required for autonomous driving control of the vehicle 10 on the generated traveling route and outputs the target control amounts to an actuator 530 installed in the vehicle 10, thereby executing vehicle control of the vehicle 10.

The first road lane division line information acquisition unit 101 captures images of the surroundings of the vehicle 10 using the camera 90, and acquires and outputs position information of the left-side and right-side road lane division lines of a lane 20 in which the vehicle 10 is traveling. Hereinafter, the position information of the road lane division line on the left side in the traveling direction of the vehicle 10 captured by the camera 90 is referred to as first left-side road lane division line information, and the position information of the road lane division line on the right side in the traveling direction of the vehicle 10 is referred to as first right-side road lane division line information. Further, the first left-side road lane division line information and the first right-side road lane division line information are collectively referred to as first road lane division line information.

FIG. 3 is a schematic diagram showing a situation of the lane when the vehicle 10 is traveling on the lane 20. In general, a white line is provided as a road lane division line on the lane. On the left side of the lane 20 in the traveling direction of the vehicle 10, for example, a first left-side road lane division line 21 indicated by a white line is provided. Further, on the right side of the lane 20 in the traveling direction of the vehicle 10, for example, a first right-side road lane division line 22 indicated by a white line is provided.

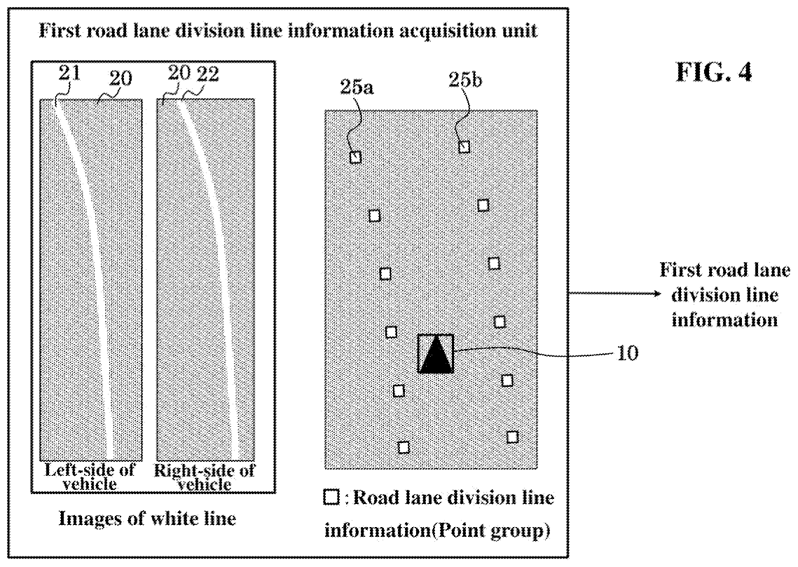

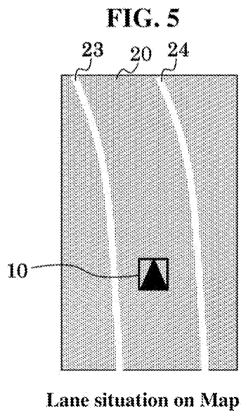

FIG. 4 is a schematic diagram for describing an operation of the first road lane division line information acquisition unit 101. The diagram on the left side in FIG. 4 is a schematic diagram of an image of the lane 20 captured by the camera 90 mounted on the vehicle 10. On the left side of the vehicle 10, the white line that is a source of the first left-side road lane division line information is captured. Further, on the right side of the vehicle 10, the white line that is a source of the first right-side road lane division line information is captured.

The first road lane division line information acquisition unit 101 converts the white lines provided as the road lane division lines on the left side and right side of the lane 20 described above into first point group data 25. The first point group data 25 corresponding to the first left-side road lane division line 21 is referred to as first left-side point group data 25a, and the first point group data 25 corresponding to the first right-side road lane division line 22 is referred to as first right-side point group data 25b. That is, the first left-side road lane division line information is constituted with each of the points of the first left-side point group data 25a, and the first right-side road lane division line information is constituted with each of the points of the first right-side point group data 25b. The diagram on the right side of FIG. 4 illustrates a state after the white lines are converted into the first point group data 25. Note that the point group data means a set of points indicating at regular intervals, positions where the road lane division lines are present in the front-back direction of the vehicle 10.

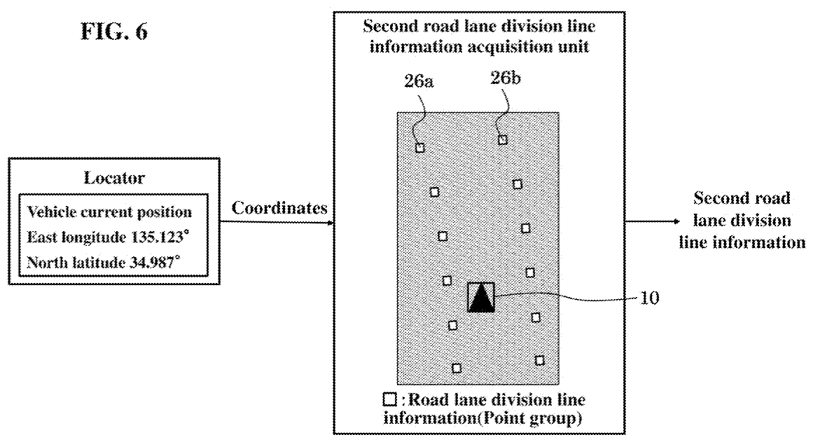

The second road lane division line information acquisition unit 102 holds map information, and acquires and outputs position information of the left-side and right-side road lane division lines of the lane 20 in which the vehicle 10 is traveling, on the basis of the own-vehicle position information acquired by the locator 91 and the map information. Hereinafter, the position information of the road lane division line on the left side in the traveling direction of the vehicle 10 based on the own-vehicle position information and the map information is referred to as second left-side road lane division line information, and the position information of the road lane division line on the right side in the traveling direction of the vehicle 10 based on the own-vehicle position information and the map information is referred to as second right-side road lane division line information. Further, the second left-side road lane division line information and the second right-side road lane division line information are collectively referred to as second road lane division line information. FIG. 5 is a schematic diagram showing a situation of the lane 20 on the map, and a second left-side road lane division line 23 based on the map information is displayed on the left side of the lane 20, and a second right-side road lane division line 24 based on the map information is displayed on the right side of the lane 20.

The second road lane division line information acquisition unit 102 converts the left-side and right-side road lane division lines of the lane 20 into second point group data 26 on the basis of the own-vehicle position information acquired by the locator 91 and the map information. The second point group data 26 corresponding to the second left-side road lane division line 23 is referred to as second left-side point group data 26a, and the second point group data 26 corresponding to the second right-side road lane division line 24 is referred to as second right-side point group data 26b. That is, the second left-side road lane division line information is constituted with each of the points of the second left-side point group data 26a, and the second right-side road lane division line information is constituted with each of the points of the second right-side point group data 26b. FIG. 6 shows a state after the road lane division lines based on the map information are converted into the second point group data 26.

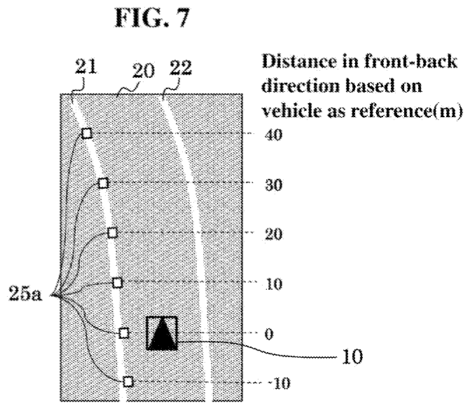

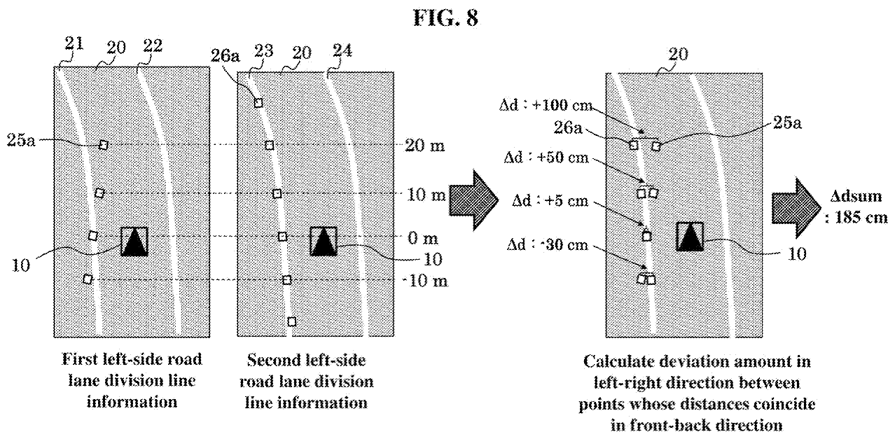

Here, the point group data will be described with reference to FIG. 7. FIG. 7 is a schematic diagram for describing point group data extracted from the road lane division line information. For example, when the road lane division line information is information based on a white line, the road lane division line on the left side in the traveling direction of the vehicle 10 is indicated by each point of the first left-side point group data 25a that is the first left-side road lane division line information. In FIG. 7, the first left-side point group data 25a is constituted with group data with a total of 6 points. That is, the white line on the left side in the traveling direction of the vehicle 10 is indicated by the first left-side point group data 25a that is point group data constituted with six points extracted from the white line. That is, the first left-side point group data 25a is the first left-side road lane division line information acquired while the vehicle 10 is traveling. Note that, in the example shown in FIG. 7, the interval between the individual points in the first left-side point group data 25a is set to 10 m. However, the interval of the point group is not limited to 10 m, and may be appropriately set depending on the situation of the road, the speed of the vehicle 10, and the like.

In the first road lane division line information and the second road lane division line information, the interval between the points in each of the point group data in the front-back direction of the vehicle 10 are substantially the same. On the other hand, in the first road lane division line information and the second road lane division line information, the ranges that can be expressed by the point group data do not necessarily coincide with each other. For example, the first road lane division line information may be set within a range of 100 m in front of and 50 m behind the vehicle 10, and the second road lane division line information may be set within a range of 300 m in front of and 100 m behind the vehicle 10. Note that such a setting method is merely an example, and may be set as appropriate depending on the situation of the road, the vehicle speed of the vehicle 10, and the like.

The road lane division line information determination unit 103 selects road lane division line information that provides an optimal own-vehicle position estimation result among the own-vehicle position estimation using the left-side road lane division line, the own-vehicle position estimation using the right-side road lane division line, and the own-vehicle position estimation using the left-side road lane division line and the right-side road lane division line, for example, on the basis of the first left-side road lane division line information including the first left-side point group data 25a extracted from the white line provided on the left side of lane 20 and the first right-side road lane division line information including the first right-side point group data 25b extracted from the white line provided on the right side of the lane 20, that is, the first road lane division line information including the first point group data 25, and also on the basis of the second left-side road lane division line information including the second left-side point group data 26a indicating the left-side road lane division line of the lane and the second right-side road lane division line information including the second right-side point group data 26b indicating the right-side road lane division line of the lane 20, that is, the second road lane division line information including the second point group data 26, the second left-side road lane division line information and the second right-side road lane division line information being acquired from the own-vehicle position information acquired by the locator 91 and the map information. The road lane division line information determination unit 103 outputs the selected road lane division line information as the best road lane division line information.

On the other hand, in a case where both of the left-side road lane division line information and the right-side road lane division line information cannot be used for the own-vehicle position estimation, the road lane division line information determination unit 103 determines that the own-vehicle position estimation cannot be performed, and outputs “invalid” as the best road lane division line information.

When the best road lane division line information output by the road lane division line information determination unit 103 is valid, the own-vehicle position estimation unit 104 estimates the own-vehicle position by appropriately correcting positions of the second road lane division line information using the road lane division line information on at least one of the left side and the right side from among the first road lane division line information and the second road lane division line information according to the best road lane division line information. The above is the outline of the configuration of the own-vehicle position estimation device 100 according to Embodiment 1.

Next, the camera 90 and the locator 91 connected to the own-vehicle position estimation device 100 will be described below. The camera 90 is installed in front side of the vehicle 10, for example, at a position where a road lane division line such as a white line can be detected as an image. The camera 90 outputs the captured image to the first road lane division line information acquisition unit 101. Note that the camera 90 is merely an example of an imaging device, and the imaging device is not limited to the camera 90 as long as the imaging device can detect a road lane division line as an image.

The locator 91 is a device for acquiring position information of the vehicle 10, and is configured with, for example, a global positioning system (GPS) receiver. Alternatively, the position of the vehicle may be measured using a global navigation satellite system (GNSS) receiver. Further, the vehicle position may be detected by a device such as an inertial navigation system using various sensors mounted on the vehicle 10. The locator 91 outputs the acquired own-vehicle position information to the second road lane division line information acquisition unit 102.

As illustrated in FIG. 1, the own-vehicle position estimation device 100 estimates the own-vehicle position of the vehicle 10, and outputs the own-vehicle position estimation result to the traveling route generation device 200. The traveling route generation device 200 generates a traveling route on the basis of the own-vehicle position estimation result and outputs the traveling route to the vehicle control device 300. The vehicle control device 300 optimally performs vehicle control such as control for autonomous driving of the vehicle 10 on the basis of the generated traveling route.

Each of operations of the road lane division line information determination unit 103 and the own-vehicle position estimation unit 104, which is a characteristic feature in the configuration of the own-vehicle position estimation device 100 according to Embodiment 1, will be described in more detail below.

<Operation of road lane division line information determination unit 103>

The road lane division line information determination unit 103 performs the following processing.

(1) A left-side deviation LDv indicating the deviation between the first left-side road lane division line information and the second left-side road lane division line information is calculated for the left-side road lane division line. The calculation method is shown below.

(2) With regard to the first left-side point group data 25a being the first left-side road lane division line information and the second left-side point group data 26a being the second left-side road lane division line information, a process of calculating a deviation amount Δd in the left-right direction of the vehicle 10 between points where the distance of each point in the point group data in the front-back direction of the vehicle 10 is the same is performed on all the point group data included in the range of the distance in which both the first left-side road lane division line information and the second left-side road lane division line information are represented.

(3) The deviation amount Δd in the left-right direction of the vehicle 10 is calculated between the point at the distance 0 m in the front-back direction of the vehicle 10 in the first left-side road lane division line information and the point at the distance 0 m in the front-back direction of the vehicle 10 in the second left-side road lane division line information.

That is, the deviation amount Δd at the distance 0 m in the front-back direction of the vehicle 10 is calculated. Similarly, the deviation amount Δd in the right-left direction is sequentially calculated at the distances 10 m and 20 m in the front-back direction and for each point within the range of the same distances in both lines.

(4) A sum Δdsum of the absolute values of the deviation amounts Δd in the left-right direction of the vehicle 10 is set as the left-side deviation LDv of the left-side road lane division line information.

By calculating the left-side deviation LDv as described above, it is possible to quantify the degree of the deviation between the first left-side road lane division line information and the second left-side road lane division line information that each represent the left-side road lane division line information. In the following description, the deviation amount in the left-right direction is simply referred to as the deviation amount.

FIG. 8 shows an example of the method of calculating the left-side deviation LDv. The diagram on the left side in FIG. 8 shows the first left-side road lane division line information represented by the first left-side point group data 25a that includes four points extracted from the image of the first left-side road lane division line indicated by a white line captured by the camera 90. The middle diagram in FIG. 8 shows the second left-side road lane division line information represented by the second left point group data 26a that includes six points extracted from the second left-side road lane division line based on the own-vehicle position information acquired by the locator 91 and the map information.

As shown by the diagram on the right side of FIG. 8, the points where the distance in the front-back direction of the vehicle 10 coincides between the first left-side point group data 25a being the first left-side road lane division line information and the second left-side point group data 26a being the second left-side road lane division line information are plotted on the same plane, and the distance between the points, that is, the deviation amount Δd, is calculated for the points.

In the example shown in FIG. 8, when the distance L in the front-back direction of the vehicle 10 is −10 m, the deviation amount Δd is −30 cm; when the distance L is 0 m, the deviation amount Δd is +5 cm; when the distance L is 10 m, the deviation amount Δd is +50 cm; when the distance L is 20 m, the deviation amount Δd is +100 cm, and thus the deviation amount Δd at each position is calculated.

Δdsum, which is a sum of the absolute values of the deviation amounts Δd, is the sum of the absolute values of the deviation amounts Δd at all points. Note that, in the case of the example shown in FIG. 8, the sum Δdsum of the absolute values of the deviation amounts Δd is 185 cm. Note that the left-side deviation LDv is represented by Δdsum.

For quantification of the left-side deviation LDv, a method other than the sum Δdsum of the absolute values of the deviation amounts Δd may be used. As the left-side deviation LDv, the maximum value of the absolute value of the deviation amount Δd at the points in the point group data may be used, or the mean square error of the deviation amounts Δd may be calculated and used as the left-side deviation LDv.

In addition to the above-described method of calculating the left-side deviation LDv, for example, before calculating the deviation amount Δd, the second point group data 26 may be parallelly translated such that centroid positions of both the first point group data 25 being the first road lane division line information and the second point group data 26 being the second road lane division line information coincide with each other with respect to all the points included in the range of the distance in the front-back direction of the vehicle 10 that are represented by both the first road lane division line information and the second road lane division line information. By applying the parallel translation processing, it is possible to calculate the left-side deviation LDv with an emphasis on the deviation amount of the road lane division line information in the left-right direction.

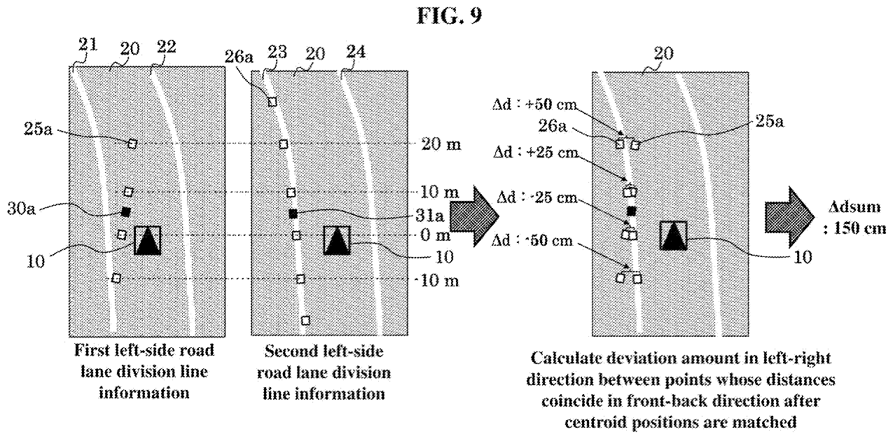

FIG. 9 illustrates an example of the calculation of the deviation in consideration of the centroid position of the point group data. The diagram on the left side of FIG. 9 shows the first left-side road lane division line information represented by the first left-side point group data 25a that includes four points extracted from an image of the first left-side road lane division line indicated by the white line, and the centroid position 30a of the first left-side point group 25a including four points, the image being captured by the camera 90. The diagram in the center of FIG. 9 shows the second left-side road lane division line information represented by the second left-side point group data 26a that includes six points extracted from the second left-side road lane division line on the basis of the map information, and the centroid position 31a of the second left-side point group data 26a including six points.

As shown in the diagram on the right side in FIG. 9, the second left-side point group data 26a is parallelly translated such that the centroid position 30a of the first left-side point group data 25a being the first left-side road lane division line information and the centroid position 31a of the second left-side point group data 26a being the second left-side road lane division line information coincide with each other, further the points with the same distance in the front-back direction of the vehicle 10 are plotted on the same plane, and the distance between the points, i.e., the deviation amount Δd, is calculated for the points.

In the example shown in FIG. 9, when the distance L in the front-back direction of the vehicle 10 is-10 m, the deviation amount Δd is −50 cm; when the distance L is 0 m, the deviation amount Δd is −25 cm; when the distance Lis 10 m, the deviation amount Δd is +25 cm; when the distance L is 20 m, the deviation amount Δd is +50 cm, and thus the deviation amount Δd is calculated at each position.

In the example shown in FIG. 9, the sum of the absolute values of the deviation amounts Δd, Δdsum, is 150 cm. In other words, the left-side deviation LDv is 150 cm.

For the right-side road lane division line information, a right-side deviation RDv is calculated using the same method as in the left-side road lane division line information.

The road lane division line information determination unit 103 determines whether or not the second left-side road lane division line information is erroneously recognized with respect to the first left-side road lane division line. Specifically, when the left-side deviation LDv is equal to or larger than a threshold Dth set in advance, the road lane division line information determination unit 103 determines that the second left-side road lane division line information is erroneously recognized. On the other hand, when the left-side deviation LDv is less than the threshold Dth set in advance, the road lane division line information determination unit 103 determines that there is no erroneous recognition in the second left-side road lane division line information.

The road lane division line information determination unit 103 further determines whether or not the second right-side road lane division line information is erroneously recognized with respect to the first right-side road lane division line. Specifically, when the right-side deviation RDv is equal to or larger than the threshold Dth set in advance, the road lane division line information determination unit 103 determines that the second right-side road lane division line information is erroneously recognized. On the other hand, when the right-side deviation RDv is less than the threshold Dth set in advance, the road lane division line information determination unit 103 determines that there is no erroneous recognition in the second right-side road lane division line information.

The road lane division line information determination unit 103 performs the following output on the basis of the above-described determination result.

(1) A case where there is no erroneous recognition in both the second left-side road lane division line information and the second right-side road lane division line information

The road lane division line information determination unit 103 outputs both the second left-side road lane division line information and the second right-side road lane division line information as the best road lane division line information.

(2) A case where there is no erroneous recognition in the second left-side road lane division line information and there is erroneous recognition in the second right-side road lane division line information

The road lane division line information determination unit 103 outputs only the second left-side road lane division line information as the best road lane division line information.

(3) A case where there is erroneous recognition in the second left-side road lane division line information and there is no erroneous recognition in the second right-side road lane division line information

The road lane division line information determination unit 103 outputs only the second right-side road lane division line information as the best road lane division line information.

(4) A case where both the second left-side road lane division line information and the second right-side road lane division line information have erroneous recognition

The road lane division line information determination unit 103 outputs “invalid” as the best road lane division line information.

The above is the outline of the operation of the road lane division line information determination unit 103.

### <Operation of Own-Vehicle Position Estimation Unit 104>

The own-vehicle position estimation unit 104 calculates a rotation angle and a parallel translation amount of each point of the second road lane division line information such that the positions of the points of the second road lane division line information coincide with the position of the points of the first road lane division line information as much as possible with respect to several points in the vicinity of the vehicle 10 in the second road lane division line information. The own-vehicle position estimation unit 104 estimates the own-vehicle position by performing rotation processing and parallel translation processing on the entire second road lane division line using the calculated rotation angle and parallel translation amount.

Note that the calculated rotation angle means a correction angle that is one of the correction amounts.

The own-vehicle position estimation unit 104 performs the following processing on the basis of the best road lane division line information output as the determination result of the road lane division line information determination unit 103.

(1) A case where the best road lane division line information is “both the second left-side road lane division line information and the second right-side road lane division line information”

The own-vehicle position estimation unit 104 calculates the rotation angle and the parallel translation amount, that is, the correction amounts, on the basis of both the second left-side road lane division line information and the second right-side road lane division line information.

(2) A case where the best road lane division line information is “only the second left-side road lane division line information”

The own-vehicle position estimation unit 104 calculates the rotation angle and the parallel translation amount, that is, the correction amounts, on the basis of only the second left-side road lane division line information.

(3) A case where the best road lane division line information is “only the second right-side road lane division line information”

The own-vehicle position estimation unit 104 calculates the rotation angle and the parallel translation amount, that is, the correction amounts, on the basis of only the second right-side road lane division line information.

(4) A case where the best road lane division line information is “invalid” The own-vehicle position estimation unit 104 does not output the estimation result of the own-vehicle position.

In the case where the best road lane division line information is “both of the second left-side road lane division line information and the second right-side road lane division line information”, the rotation angle and the parallel translation amount are calculated using twice as many points as in the case where the best road lane division line information is only one of them.

The reason for the above-described processing is as follows. In the second road lane division line information based on the map information, the shape of the road lane division line is accurate because of the accuracy of the map information. However, since the own-vehicle position information acquired by the locator 91 includes a measurement error, the map information based on the own-vehicle position information has a characteristic that the position of the road lane division line with respect to the vehicle 10 is inaccurate. On the other hand, the first road lane division line information based on the image captured by the camera 90 has a characteristic that the position of a point in the vicinity of the vehicle 10 with respect to the vehicle 10 is accurate but the measurement error of a point far from the vehicle 10 is large. Therefore, by processing the first road lane division line information and the second road lane division line information as described above, the disadvantages of the two are canceled out, and the advantages of the two are synergistically utilized, so that more accurate road lane division line information can be obtained.

### <Own-Vehicle Position Estimation Method According to Embodiment 1>

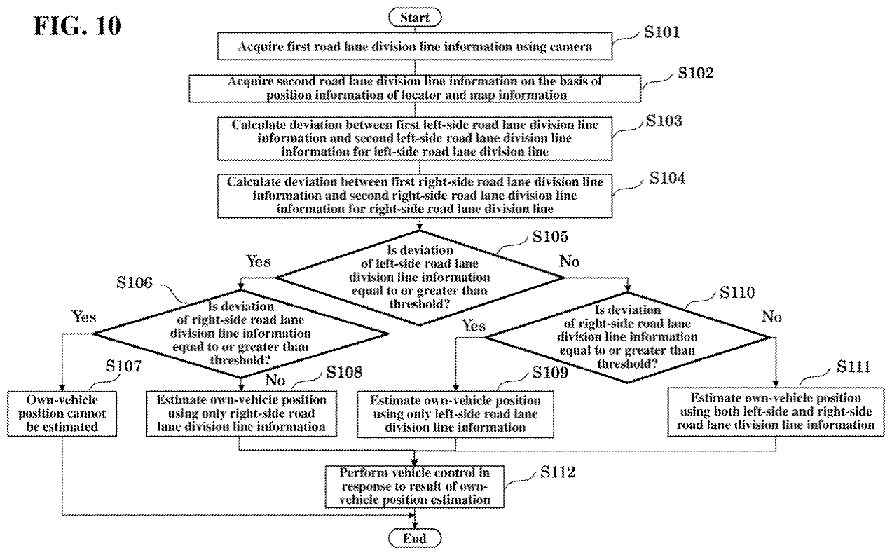

The own-vehicle position estimation method using the own-vehicle position estimation device 100 according to Embodiment 1 will be described below with reference to the flowchart of FIG. 10. Note that step S112, which is the last step, corresponds to the operation of the traveling route generation device 200 and the vehicle control device 300 based on the output of the own-vehicle position estimation device 100.

First, in step S101, the first road lane division line information acquisition unit 101 captures images of the surroundings of the vehicle 10 with the camera 90, and outputs the first road lane division line information including the first left-side road lane division line information and the first right-side road lane division line information, which are the position information of the left-side and right-side road lane division lines of the lane 20 in which the vehicle 10 is traveling, and the process proceeds to step S102.

In step S102, on the basis of the own-vehicle position information acquired by the locator 91 and the map information, the second road lane division line information acquisition unit 102 outputs the second road lane division line information including the second left-side road lane division line information and the second right-side road lane division line information, which are the position information of the left-side and right-side road lane division lines of the lane 20 in which the vehicle 10 is traveling, and the process proceeds to step S103.

In step S103, the road lane division line information determination unit 103 calculates the deviation (left-side deviation LDv) between the first left-side road lane division line information and the second left-side road lane division line information for the left-side road lane division line, and the process proceeds to step S104.

In step S104, the road lane division line information determination unit 103 calculates the deviation (right-side deviation RDv) between the first right-side road lane division line information and the second right-side road lane division line information for the right-side road lane division line, and the process proceeds to step S105.

In step S105, the road lane division line information determination unit 103 determines whether or not the deviation of the left-side road lane division line information (left-side deviation LDv) is equal to or greater than the threshold Dth. If the deviation is equal to or greater than the threshold Dth, the process proceeds to step S106, and when the deviation is less than the threshold Dth, the process proceeds to step S110.

In step S106, the road lane division line information determination unit 103 determines whether the deviation of the right-side road lane division line information (right-side deviation RDv) is equal to or greater than the threshold Dth. If the deviation is equal to or greater than the threshold Dth, this corresponds to the case where both the second left-side road lane division line information and the second right-side road lane division line information are misrecognized, and thus the road lane division line information determination unit 103 outputs “invalid” as the best road lane division line information and the process proceeds to step S107. On the other hand, if the deviation is less than the threshold Dth, this corresponds to the case where there is misrecognition in the second left-hand road lane division line information and there is no misrecognition in the second right-hand road lane division line information, the road lane division line information determination unit 103 outputs only the second right-hand road lane division line information as the best road lane division line information and the process proceeds to step S108.

In step S107, on the basis of the result that “invalid” is output as the best road lane division line information from the road lane division line information determination unit 103, the own-vehicle position estimation unit 104 determines that the own-vehicle position cannot be estimated and does not output the estimation result of the own-vehicle position.

If it is determined in step S106 that the deviation (right-side deviation RDv) of the right-side road lane division line information is less than the threshold Dth, the own-vehicle position estimation unit 104 estimates the own-vehicle position using only the second right-side road lane division line information, which is the best road lane division line information, in step S108, and the process proceeds to step S112.

Next, if the deviation is less than the threshold Dth in step S105, the processing in this case will be described. In step S110, the road lane division line information determination unit 103 determines whether the deviation of the right-side road lane division line information (right-side deviation RDv) is equal to or greater than the threshold Dth. If the deviation is equal to or greater than the threshold Dth, this corresponds to the case where there is no misrecognition in the second left-side road lane division line information but there is misrecognition in the second right-side road lane division line information, and thus the road lane division line information determination unit 103 outputs only the second left-side road lane division line information as the best road lane division line information, and the process proceeds to step S109. On the other hand, if the deviation is less than the threshold Dth, this corresponds to the case where there is no misrecognition in both the second left-side road lane division line information and the second right-side road lane division line information, and thus the road lane division line information determination unit 103 outputs both the second left-side road lane division line information and the second right-side road lane division line information as the best road lane division line information, and then the process proceeds to step S111.

If it is determined in step S110 that the deviation of the right-side road lane division line information (right-side deviation RDv) is equal to or greater than the threshold Dth, then in step S109, the own-vehicle position estimation unit 104 estimates the own-vehicle position using only the second left-side road lane division line information that is the best road lane division line information, and then the process proceeds to step S112.

If it is determined in step S110 that the deviation of the right-side road lane division line information (right-side deviation RDv) is less than the threshold Dth, then in step S111, the own-vehicle position estimation unit 104 estimates the own-vehicle position using both the second left-side road lane division line information and the second right-side road lane division line information that are the best road lane division line information, and then the process proceeds to step S112.

Lastly, in step S112, the traveling route generation device 200 and the vehicle control device 300 perform vehicle control in response to the best road lane division line information, which is the result of the own-vehicle position estimation output from the own-vehicle position estimation unit 104 in any of step S108, step S109, and step S111. The above is an overview of the own-vehicle position estimation method using the own-vehicle position estimation device 100 according to Embodiment 1.

In the case where the misrecognition occurs in the first road lane division line information, it will deviate significantly from the second road lane division line information. Therefore, by the processing as described above, it is possible to select the road lane division line information, for example, in such a way that road lane division line information that causes a large deviation in the recognition results between the first road lane division line information acquired from the camera 90 and the second road lane division line information based on the own-vehicle position information acquired from the locator 91 and the map information is not used for the own-vehicle position estimation. As a result, even when the recognition state of the road lane division line information changes dynamically, highly accurate own-vehicle position estimation can be continued.

In other words, by dynamically changing the road lane division line information used for estimating the own-vehicle position in accordance with the status of occurrence of misrecognition, the own-vehicle position estimation device according to Embodiment 1 can continuously provide highly accurate own-vehicle position estimation as long as at least one piece of the road lane division line information is recognized normally.

By using the own-vehicle position estimation device 100 according to Embodiment 1, even if the white line that serves as a mark for guiding a vehicle to a branching/merging road is in a state where the white line is omitted or blurred at a point in a driving lane where there is a road branching/merging occurs in particular, the possibility of continuing to estimate the own-vehicle position at the branching/merging road is increased.

### Effects of Embodiment 1

According to the own-vehicle position estimation device and the own-vehicle position estimation method according to Embodiment 1, each of the deviation between the first left-side road lane division line information and the second left-side road lane division line information and the deviation between the first right-side road lane division line information and the second right-side road lane division line information is calculated, and only if the deviation is less than the threshold, the second road lane division line information is used for the own-vehicle position estimation, bringing about an effect in that the own-vehicle position estimation device and the own-vehicle position estimation method can be obtained in which highly accurate own-vehicle position estimation is continuously possible.

### Embodiment 2

### <Configuration of Own-Vehicle Position Estimation Device According to Embodiment 2>

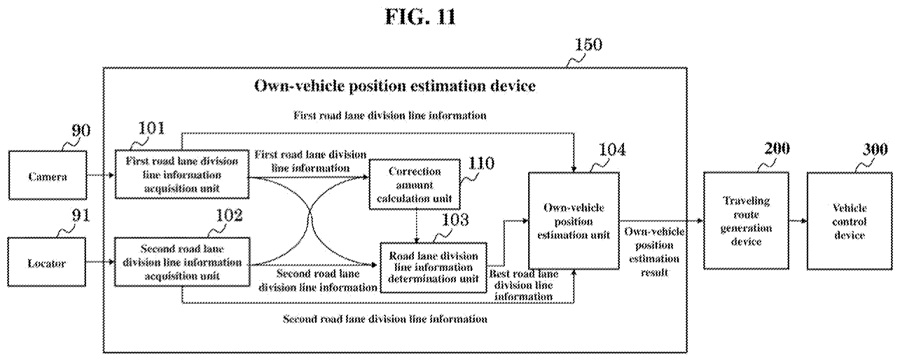

FIG. 11 is a block diagram illustrating a configuration of an own-own-vehicle position estimation device 150 according to Embodiment 2. The own-own-vehicle position estimation device 150 according to Embodiment 2 includes a correction amount calculation unit 110 in addition to the configuration of the own-vehicle position estimation device 100 according to Embodiment 1. The own-own-vehicle position estimation device 150 outputs a vehicle position estimation result to the traveling route generation device 200, and the traveling route generation device 200 outputs the generated traveling route to the vehicle control device 300. Only the correction amount calculation unit 110 that is different from the configuration of the own-vehicle position estimation device 100 according to Embodiment 1 will be described below.

The correction amount calculation unit 110 calculates three types of correction amounts in the following own-vehicle position estimation processing with respect to, for example, the first road lane division line information based on the images of the surroundings of the vehicle 10 captured by the camera 90 and the second road lane division line information based on the own-vehicle position information acquired from the locator 91 and the map information, and outputs the calculated correction amounts to the road lane division line information determination unit 103.

(1) First correction amount using both left-side and right-side road lane division line information for estimating own-vehicle position

(2) Second correction amount using only left-side road lane division line information for estimating own-vehicle position

(3) Third correction amount using only right-side road lane division line information for estimating own-vehicle position

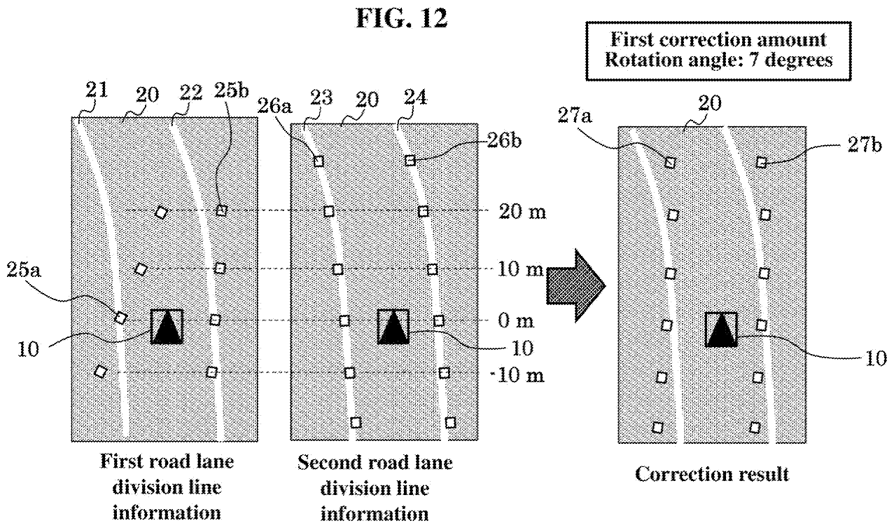

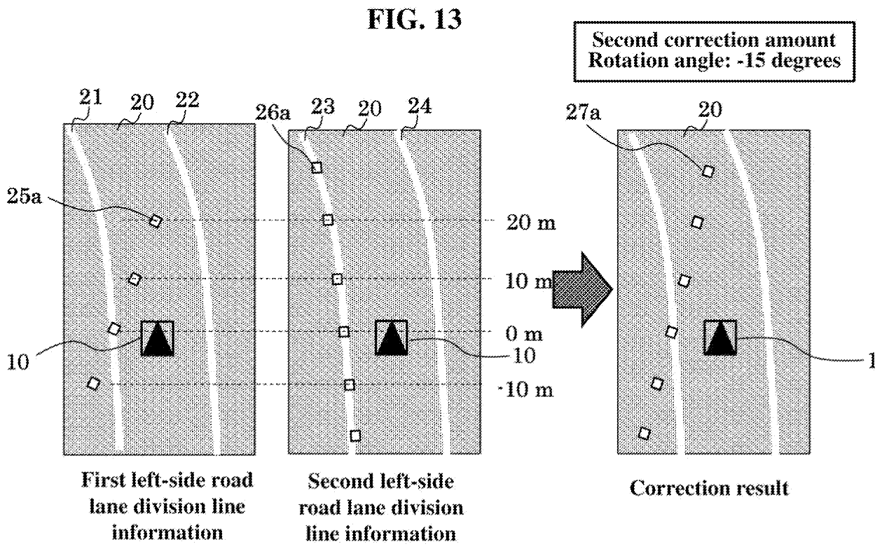

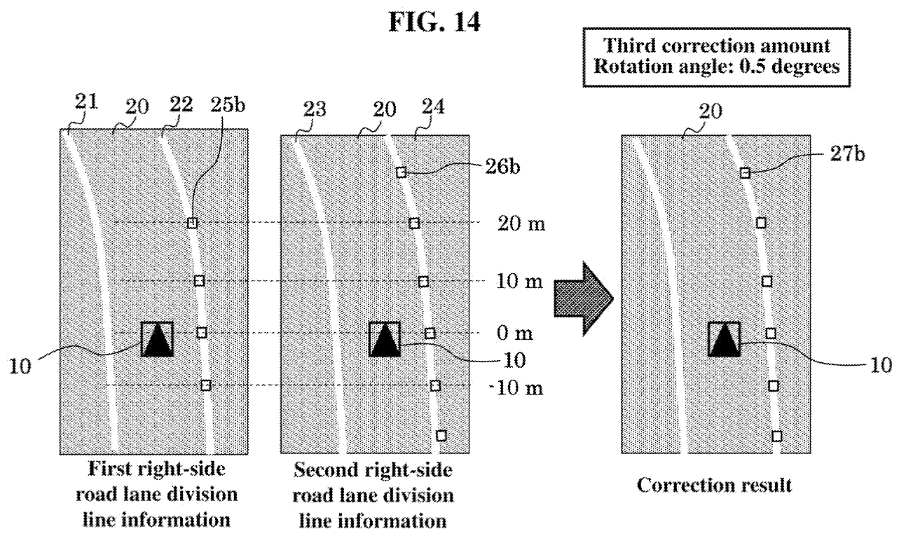

With regard to the three types of correction amounts described above, the case (1) will be described with reference to FIG. 12, the case (2) will be described with reference to FIG. 13, and the case (3) will be described with reference to FIG. 14.

### <(1) First Correction Amount Using Both Left-Side and Right-Side Road Lane Division Line Information for Estimating Own-Vehicle Position>

FIG. 12 is a schematic diagram illustrating the first correction amount using both the left-side and right-side road lane division line information for estimating the own vehicle position.

As shown in the left diagram and the center diagram of FIG. 12, with regard to the first left-side point group data 25a being the first left-side road lane division line information and the second left-side point group data 26a being the second left-side road lane division line information, processing of calculating a deviation amount Δd between points where the distance in the point group data in the front-back direction of the vehicle 10 is the same is performed on all the point group data included in the range of the distance in which both the first left-side road lane division line information and the second left-side road lane division line information are represented. Specifically, the deviation amount Δd is sequentially calculated for the points within the range of the same distance in both of the data, and the sum Δdsum of the absolute values of the deviation amounts Δd, that is, the left-side deviation LDv of the left-side road lane division line information is obtained.

The same processing as that for the left-side road lane division line information is performed for the first right-side point group information 25b being the first right-side road lane division line information and the second right-side point group information 26b being the second right-side road lane division line information. As a result, the right-side deviation RDv of the right-side road lane division line information is obtained.

The first correction amount is calculated using both the left-side deviation LDv and the right-side deviation RDv. The correction amount is specifically represented by a rotation angle. By the application of the rotation angle being the first correction amount, the second left-side point group data 26a and the second right-side point group data 26b that are the second road lane division line information are converted into second left-side corrected point group data 27a and second right-side corrected point group data 27b after the application of the first correction amount. The diagram on the right side of FIG. 12 illustrates the second left-side corrected point group data 27a and the second right-side corrected point group data 27b in a case where the first correction amount is set to the rotation angle of 7 degrees as an example.

### <(2) Second Correction Amount Using Only Left-Side Road Lane Division Line Information for Estimating Own-Vehicle Position>

FIG. 13 is a schematic diagram illustrating the second correction amount using only the left-side road lane division line information for estimating the own-vehicle position.

As shown in the left diagram and the center diagram of FIG. 13, with regard to the first left-side point group data 25a being the first left-side road lane division line information and the second left-side point group data 26a being the second left-side road lane division line information, processing of calculating a deviation amount Δd between points where the distance in the point group data in the front-back direction of the vehicle 10 is the same is performed on all the point group data included in the range of the distance in which both the first left-side road lane division line information and the second left-side road lane division line information are represented. Specifically, the deviation amount Δd is sequentially calculated for the points within the range of the same distance in both of the data, and the sum Δdsum of the absolute values of the deviation amounts Δd, that is, the left-side deviation LDv of the left-side road lane division line information is obtained.

The left-side deviation LDv is used to calculate the second correction amount. By the application of the rotation angle being the second correction amount, the second left-side point group data 26a being the second road lane division line information is converted into the second left-side corrected point group data 27a after the application of the second correction amount. The diagram on the right side of FIG. 13 illustrates the second left-side corrected point group data 27a in a case where the second correction amount is set to the rotation angle of −15 degrees as an example.

### <(3) Third Correction Amount Using Only Right-Side Road Lane Division Line Information for Estimating Own-Vehicle Position>

FIG. 14 is a schematic diagram illustrating the third correction amount using only the right-side road lane division line information for estimating the own-vehicle position.

As shown in the left diagram and the center diagram of FIG. 14, with regard to the first right-side point group data 25b being the first right-side road lane division line information and the second right-side point group data 26b being the second right-side road lane division line information, processing of calculating a deviation amount Δd between points where the distance in the point group data in the front-back direction of the vehicle 10 is the same is performed on all the point group data included in the range of the distance in which both the first right-side road lane division line information and the second right-side road lane division line information are represented. Specifically, the deviation amount Δd is sequentially calculated for the points within the range of the same distance in both of the data, and the sum Δdsum of the absolute values of the deviation amounts Δd, that is, the right-side deviation RDv of the right-side road lane division line information is obtained.

The right-side deviation RDv is used to calculate the third correction amount. By the application of the rotation angle being the third correction amount, the second right-side point group data 26b being the second road lane division line information is converted into the second right-side corrected point group data 27b after the application of the third correction amount. The diagram on the right side of FIG. 14 illustrates the second right-side corrected point group data 27b in a case where the third correction amount is set to the rotation angle of 0.5 degrees as an example.

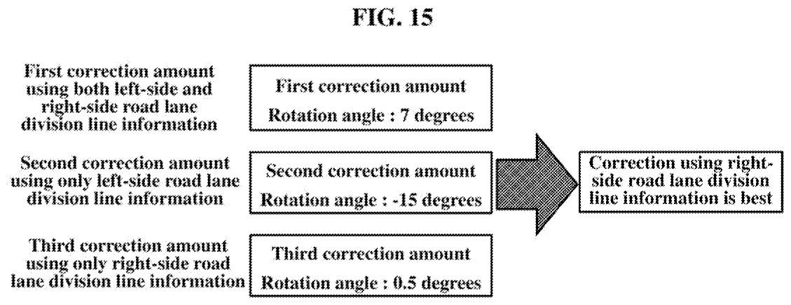

By performing the above-described each piece of processing, three kinds of correction amounts, that is, the first correction amount using both the left-side road lane division line information and the right-side road lane division line information, the second correction amount using only the left-side road lane division line information, and the third correction amount using only the right-side road lane division line information, are obtained. In the above-described case, it can be evaluated that the third correction amount having the smallest rotation angle among the correction amounts has the smallest deviation amount. In other words, the second right-side road lane division line information is output as the best road lane division line information. A series of flows described above is shown in FIG. 15. In short, the correction amount calculation unit 110 calculates at least one or more of the correction angles in the rotation processing and the parallel translation amounts in the parallel translation processing as the first correction amount, the second correction amount, and the third correction amount.

<Own-vehicle position estimation method according to Embodiment 2>

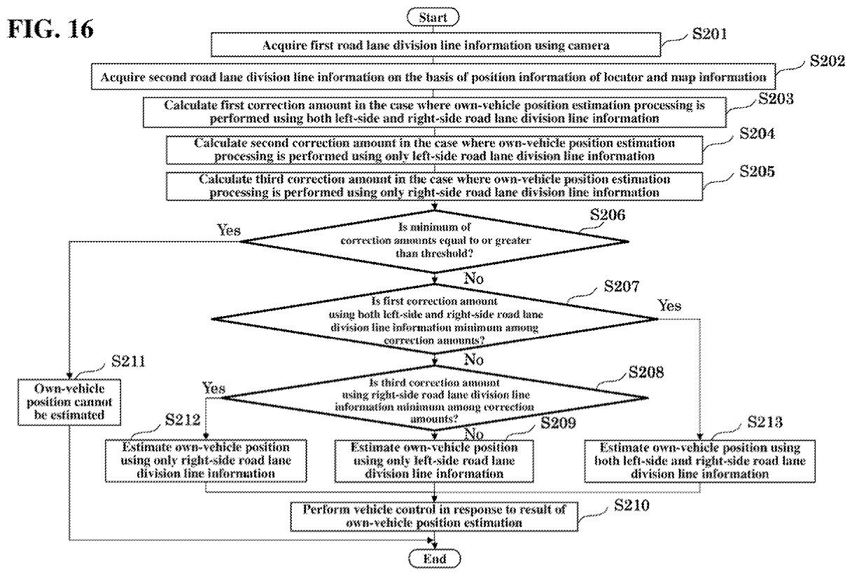

The own-vehicle position estimation method using the own-vehicle position estimation device 150 according to Embodiment 2 will be described below with reference to the flowchart of FIG. 16. Note that, step S210, which is the last step, corresponds to the operation of the traveling route generation device 200 and the vehicle control device 300 based on the output of the own-vehicle position estimation device 150.

First, in step S201, the first road lane division line information acquisition unit 101 captures images of the surroundings of the vehicle 10 with the camera 90, and outputs the first road lane division line information including the first left-side road lane division line information and the first right-side road lane division line information, which are the position information of the left-side and right-side road lane division lines of the lane 20 in which the vehicle 10 is traveling, and the process proceeds to step S202.

In step S202, on the basis of the own-vehicle position information acquired by the locator 91 and the map information, the second road lane division line information acquisition unit 102 outputs the second road lane division line information including the second left-side road lane division line information and the second right-side road lane division line information, which are the position information of the left-side and right-side road lane division lines of the lane 20 in which the vehicle 10 is traveling, and the process proceeds to step S203.

In step S203, the correction amount calculation unit 110 calculates the first correction amount in the case where the own-vehicle position estimation processing is performed using both the left-side and right-side road lane division line information, and the process proceeds to step S204.

In step S204, the correction amount calculation unit 110 calculates the second correction amount in the case where the own-vehicle position estimation processing is performed using only the left-side road lane division line information, and the process proceeds to step S205.

In step S205, the correction amount calculation unit 110 calculates the third correction amount in the case where the own-vehicle position estimation processing is performed using only the right-side road lane division line information, and the process proceeds to step S206.

In step S206, the road lane division line information determination unit 103 determines whether or not the minimum correction amount, which is the minimum of the three types of correction amounts calculated by the correction amount calculation unit 110, is equal to or greater than a threshold (threshold correction amount DAth). If the minimum correction amount is equal to or greater than the threshold correction amount DAth, the process proceeds to step S211. If the minimum correction amount is less than the threshold correction amount DAth, the process proceeds to step S207.

In step S207, the road lane division line information determination unit 103 determines whether or not the first correction amount using both the left-side and right-side road lane division line information is the minimum among the three types of correction amounts calculated by the correction amount calculation unit 110. If the first correction amount is the minimum, the process proceeds to step S213. If the first correction amount is not the minimum, the process proceeds to step S208.

In step S208, the road lane division line information determination unit 103 determines whether or not the third correction amount using the right-side road lane division line information is the minimum among the three types of correction amounts calculated by the correction amount calculation unit 110. If the third correction amount is the minimum, the process proceeds to step S212. If the third correction amount is not the minimum, the process proceeds to step S209.

In step S211, on the basis of the result that “invalid” is output as the best road lane division line information from the road lane division line information determination unit 103, the own-vehicle position estimation unit 104 determines that the own-vehicle position cannot be estimated and does not output the estimation result of the own-vehicle position. This is because, in step S206, if the minimum correction amount among the three types of correction amounts calculated by the correction amount calculation unit 110 is equal to or greater than the threshold correction amount DAth, the road lane division line information determination unit 103 outputs “invalid” as the best road lane division line information.

If it is determined in step S207 that the first correction amount using both the left-side and right-side road lane division line information is the minimum, in step S213, the own-vehicle position estimation unit 104 estimates the own-vehicle position using both the first left-side road lane division line information and the second right-side road lane division line information that are the best road lane division line information, and the process proceeds to step S210.

If it is determined in step S208 that the third correction amount using the right-side road lane division line information is not the minimum, in step S209, the own-vehicle position estimation unit 104 estimates the own-vehicle position using only the second left-side road lane division line information that is the best road lane division line information, and the process proceeds to step S210.

If it is determined in step S208 that the third correction amount using the right-side road lane division line information is the minimum, in step S212, the own-vehicle position estimation unit 104 estimates the own-vehicle position using only the second right-side road lane division line information that is the best road lane division line information, and the process proceeds to step S210.

Lastly, in step S210, the traveling route generation device 200 and the vehicle control device 300 perform vehicle control in response to the best road lane division line information that is the own-vehicle position estimation result output from the own-vehicle position estimation unit 104 in any of step S209, step S212, and step S213. The above is an overview of the own-vehicle position estimation method using the own-vehicle position estimation device 150 according to Embodiment 2.

Note that, without providing the correction amount calculation unit 110, the own-vehicle position estimation unit 104 may be provided with the above-described correction amount calculation and output function, and the own-vehicle position estimation unit 104 may calculate the correction amount.

When erroneous recognition occurs in the first road lane division line information, the first road lane division line information significantly deviates from the second road lane division line information based on the map information, that is, the deviation increases. Therefore, when the road lane division line information in which the erroneous recognition has occurred is used, the correction amount increases. Therefore, by the processing as described above, it is possible to select the road lane division line information in such a way that the road lane division line information in which the correction amount increases: that is, the erroneous recognition occurs, is not used for the own-vehicle position estimation. Therefore, even when the recognition state of the road lane division line information changes dynamically, highly accurate own-vehicle position estimation can be continued.

### Effects of Embodiment 2

According to the own-vehicle position estimation device and the own-vehicle position estimation method according to Embodiment 2, three types of correction amounts are calculated, and a combination of the road lane division line information having the minimum correction amount is selected and used for the own-vehicle position estimation, bringing about an effect in that the own-vehicle position estimation device and the own-vehicle position estimation method can be obtained in which highly accurate own-vehicle position estimation is continuously possible.

### Embodiment 3

In the own-vehicle position estimation device and the own-vehicle position estimation method according to Embodiment 3, the first road lane division line information acquisition unit 101 acquires first road lane division line information reliability serving as an index of the reliability of the first road lane division line information on the basis of the images of the lane captured by the camera 90. In addition, the second road lane division line information acquisition unit 102 acquires second road lane division line information reliability serving as an index of the reliability of the second road lane division line information on the basis of the own-vehicle position information acquired by the locator 91 and the map information.

The first road lane division line information reliability indicates reliability as the information in the first left-side road lane division line information that is the position information of the first left-side road lane division line and in the first right-side road lane division line information that is the position information of the first right-side road lane division line. Similarly, the second road lane division line information reliability indicates reliability as the information in the second left-side road lane division line information that is the position information of the second left-side road lane division line and in the second right-side road lane division line information that is the position information of the second right-side road lane division line.

Using the first road lane division line information reliability and the second road lane division line information reliability, and on the basis of the first left-side road lane division line information, first left-side road lane division line information reliability, the first right-side road lane division line information, and first right-side road lane division line information reliability, and also the second left-side road lane division line information, second left-side road lane division line information reliability, the second right-side road lane division line information, and second right-side road lane division line information reliability, the road lane division line information determination unit 103 selects a combination of road lane division line information that can provide an optimal vehicle position estimation result from among the vehicle position estimation using the left-side road lane division line, the vehicle position estimation using the right-side road lane division line, and the vehicle position estimation using the left-side road lane division line and the right-side road lane division line. The road lane division line information obtained as a result of the selection is output as the best road lane division line information.

For example, if the white line being the first left-side road lane division line is blurred, the first left-side road lane division line information reliability is low, and thus the vehicle position estimation using the left-side road lane division line is not optimal when the own-vehicle position is estimated: that is, it is determined not to be the best road lane division line information.

If both the first road lane division line information reliability and the second road lane division line information reliability are low and cannot be used for the vehicle position estimation, the road lane division line information determination unit 103 determines that the vehicle position estimation cannot be performed and outputs “invalid” as the best road lane division line information.

If the best road lane division line information output by the road lane division line information determination unit 103 is valid, the own-vehicle position estimation unit 104 estimates the vehicle position by appropriately correcting the position of the second road lane division line information using the road lane division line information on at least one of the left side and the right side from among the first road lane division line information and the second road lane division line information according to the best road lane division line information.

### Effects of Embodiment 3

According to the own-vehicle position estimation device and the own-vehicle position estimation method of Embodiment 3, the best road lane division line information is acquired on the basis of the first road lane division line information reliability and the second road lane division line information reliability, bringing about an effect in that the own-vehicle position estimation device and the own-vehicle position estimation method can be obtained in which highly accurate own-vehicle position estimation is continuously possible.

### Embodiment 4

### <Configuration of Vehicle Control System According to Embodiment 4>

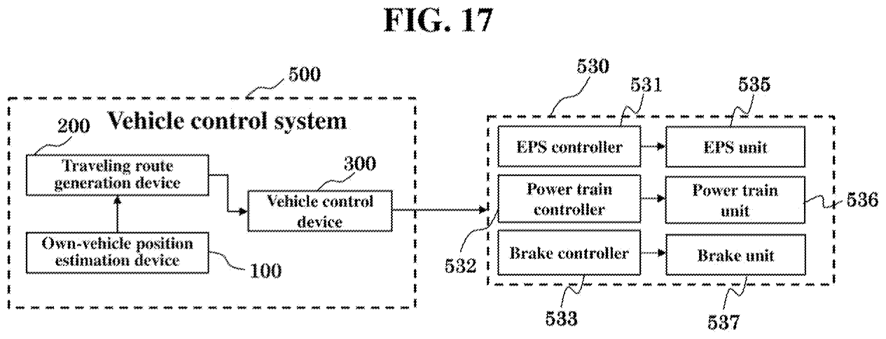

FIG. 17 is a block diagram illustrating a configuration of a vehicle control system 500 according to Embodiment 4. The vehicle control system 500 includes the own-vehicle position estimation device 100, the traveling route generation device 200, and the vehicle control device 300 according to Embodiment 1.

The own-vehicle position estimation device 100 outputs an own-vehicle position estimation result of the vehicle 10 to the traveling route generation device 200. Note that the own-vehicle position estimation device 150 according to Embodiment 2 may be used instead of the own-vehicle position estimation device 100 according to Embodiment 1.

The traveling route generation device 200 generates a traveling route for the vehicle 10 up to the target point using the own-vehicle position estimation result of the vehicle 10 output from the own-vehicle position estimation device 100. Note that a known method can be applied to the generation of the traveling route.

The vehicle control device 300 sets a target trajectory and a target vehicle speed, which are target control amounts necessary for the vehicle 10 to travel on the traveling route generated by the traveling route generation device 200, and further calculates a target steering amount and target acceleration/deceleration necessary for following the target trajectory and the target vehicle speed. Note that a known calculation method can be applied to the calculation of the target steering amount and the target acceleration/deceleration. The above is the description on the configuration of the vehicle control system 500.

Hereinafter, vehicle control of the vehicle 10 by the vehicle control system 500 will be described. The target steering amount and the target acceleration/deceleration, which are the target control amounts calculated in the vehicle control device 300 of the vehicle control system 500, are output to the actuator 530, and the autonomous driving control of the vehicle 10 is performed.

The actuator 530 includes an electronic power steering (EPS) controller 531, a power train controller 532, a brake controller 533, an EPS unit 535, a power train unit 536, and a brake unit 537.

The actuator 530 controls the EPS, the brake, and the accelerator so that the vehicle 10 follows the target steering amount and the target acceleration/deceleration.

The EPS controller 531 controls the EPS unit 535 on the basis of the target steering amount output from the vehicle control system 500. For example, the steering angle for the vehicle 10 to travel along the target trajectory can be controlled by the EPS controller 531.

The powertrain controller 532 controls the powertrain unit 536 so as to achieve the target acceleration/deceleration output from the vehicle control system 500. Further, when the driver instead of the autonomous driving control performs speed control, the powertrain unit 536 is controlled on the basis of an accelerator pedal depression amount.

The brake controller 533 controls the brake unit 537 so as to achieve the target acceleration/deceleration output from the vehicle control system 500. Further, when the driver instead of the autonomous driving control performs speed control, the brake unit 537 is controlled on the basis of the brake pedal depression amount.

### Effects of Embodiment 4

As described above, in the vehicle control system according to Embodiment 4, the own-vehicle position information is calculated with high accuracy by the own-vehicle position estimation device according to Embodiment 1 or Embodiment 2, bringing about an effect in that the vehicle control with excellent stability can be achieved on the basis of the own-vehicle position information with high accuracy.

The configuration in which the functions of the components of the own-vehicle position estimation devices 100 and 150 and the vehicle control system 500 according to Embodiment 1 to Embodiment 4 are achieved by one of hardware, software, and the like has been described above. However, this is not a limitation, and a configuration may be adopted in which some of the components of the own-vehicle position estimation devices 100 and 150 and the vehicle control system 500 are implemented by dedicated hardware, and some other components are implemented by software or the like.

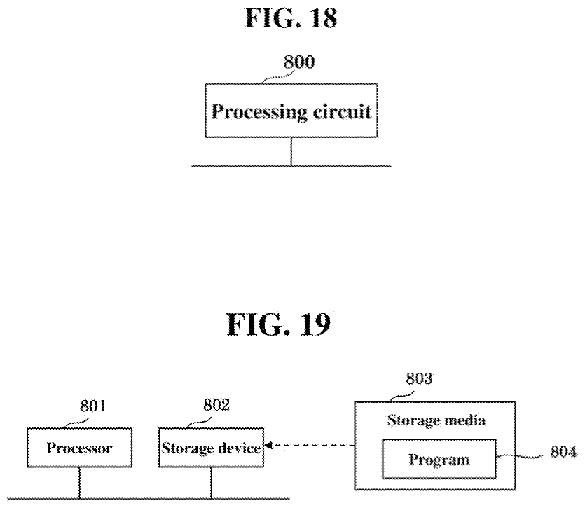

For example, as shown in FIG. 18 and FIG. 19, the functions of some components can be implemented by a processing circuit 800 as dedicated hardware, and the functions of some other components can be implemented by the processing circuit 800 as a processor 801 reading and executing a program stored in a memory 802, the program with which a computer or the like executes the own-vehicle position estimation method according to Embodiment 1 to Embodiment 3.

Further, as shown in FIG. 19, the setting data used by each functional unit and the like in the own-vehicle position estimation devices 100 and 150 may be installed in the memory 802 from a storage medium 803 storing a part of software, that is, the program 804 with which a computer or the like executes the own-vehicle position estimation method according to Embodiment 1 to Embodiment 3.

As described above, the own-vehicle position estimation devices 100 and 150 and the vehicle control system 500 according to Embodiment 1 to Embodiment 4 can implement the above-described functions by the hardware, the software, or the like, or a combination thereof.

### Summary of Various Aspects of Present Application

Hereafter, various aspects of the present application are described together as supplementary notes.

### Supplementary Note 1

The own-vehicle position estimation device for estimating an own-vehicle position of a vehicle traveling on a road defined by a left-side road lane division line and a right-side road lane division line includes the first road lane division line information acquisition unit to acquire the first road lane division line information including the first left-side road lane division line information indicating the left-side road lane division line and the first right-side road lane division line information indicating the right-side road lane division line, the first left-side road lane division line and the first right-side road lane division line being detected by the imaging device mounted on the vehicle, the second road lane division line information acquisition unit to acquire the second road lane division line information including the second left-side road lane division line information indicating the left-side road lane division line and the second right-side road lane division line information indicating the right-side road lane division line, the second left-side road lane division line and the second right-side road lane division line being acquired by a method different from the detection method by the imaging device, the road lane division line information determination unit to determine a combination of the road lane division line information to be used for estimating the own-vehicle position on the basis of the first road lane division line information and the second road lane division line information, and the own-vehicle position estimation unit to estimate the own-vehicle position by correcting the second road lane division line information using the combination of the road lane division line information determined by the road lane division line information determination unit.

### Supplementary Note 2

The own-vehicle position estimation device according to Supplementary Note 1 is characterized in that the road lane division line information determination unit determines the combination of the road lane division line information to be used for estimating the own-vehicle position on the basis of at least one of a deviation between the first left-side road lane division line information and the second left-side road lane division line information regarding the left-side road lane division line information and a deviation between the first right-side road lane division line information and the second right-side road lane division line information regarding the right-side road lane division line information.

### Supplementary Note 3

The own-vehicle position estimation device according to Supplementary Note 2 is characterized in that the first road lane division line information acquisition unit acquires, as the first road lane division line information, the first point group data including the first left-side point group data and the first right-side point group data, the second road lane division line information acquisition unit acquires, as the second road lane division line information, the second point group data including the second left-side point group data and the second right-side point group data, and the deviation is calculated using at least one of the point-to-point distance of points corresponding to each other among the points of the first left-side point group data and the points of the second left-side point group data and the point-to-point distance of points among the points of the first right-side point group data and the points of the second right-side point group data.

### Supplementary Note 4

The own-vehicle position estimation device according to Supplementary Note 2 is characterized in that the first road lane division line information acquisition unit acquires, as the first road lane division line information, the first point group data including first left-side point group data and first right-side point group data, the second road lane division line information acquisition unit acquires, as the second road lane division line information, the second point group data including second left-side point group data and second right-side point group data, and the deviation is calculated using at least one of the point-to-point distance of points corresponding to each other among the points of the first left-side point group data and the points of the second left-side point group data in a case where the centroid position of the points of the first left-side point group data and the centroid position of the points of the second left-side point group data are matched and the point-to-point distance of points among the points of the first right-side point group data and the points of the second right-side point group data in a case where the centroid position of the points of the first right-side point group data and the centroid position of the points of the second right-side point group data are matched.

### Supplementary Note 5

The own-vehicle position estimation device according to Supplementary Note 1, further includes the correction amount calculation unit to calculate at least two or more correction amounts among the first correction amount calculated in a case where a combination of the first left-side road lane division line information, the first right-side road lane division line information, the second left-side road lane division line information, and the second right-side road lane division line information is used, the second correction amount calculated in a case where a combination of the first left-side road lane division line information and the second left-side road lane division line information is used, and the third correction amount calculated in a case where a combination of the first right-side road lane division line information and the second right-side road lane division line information is used, wherein the road lane division line information determination unit determines a combination of the road lane division line information to be used for estimating the own-vehicle position on the basis of the two or more correction amounts calculated by the correction amount calculation unit.

### Supplementary Note 6

The own-vehicle position estimation device according to Supplementary Note 5 is characterized in that the correction amount calculation unit calculates at least one or more of a correction angle in the rotation processing and a translation amount in the translation processing as the first correction amount, the second correction amount, and the third correction amount, and the own-vehicle position estimation unit estimates the own-vehicle position through a correction by performing the rotation processing and the translation processing with respect to the second point group data included in the second road lane division line information acquired by the second road lane division line information acquisition unit.

### Supplementary Note 7

The own-vehicle position estimation device according to Supplementary Note 1 is characterized in that the first road lane division line information acquisition unit further acquires the first road lane division line information reliability to be an index of a reliability for the first road lane division line information, the second road lane division line information acquisition unit further acquires the second road lane division line information reliability to be an index of a reliability for the second road lane division line information, and the road lane division line information determination unit determines a combination of the road lane division line information to be used for estimating the own-vehicle position using at least one of the first road lane division line information reliability and the second road lane division line information reliability.

### Supplementary Note 8

The own-vehicle position estimation device according to any one of Supplementary Notes 1 to 7 is characterized in that the second road lane division line information is based on the map information.

### Supplementary Note 9

The vehicle control system includes the own-vehicle position estimation device according to any one of Supplementary Notes 1 to 8 to estimate an own-vehicle position on the basis of the road lane division line information, the traveling route generation device to generate a traveling route for the vehicle that reaches up to a target point on the basis of the own-vehicle position, using the own-vehicle position output from the own-vehicle position estimation device, and the vehicle control device to set a target trajectory and a target speed to be used for performing the vehicle control of the vehicle on the generated traveling route.

### Supplementary Note 10

The own-vehicle position estimation method for estimating an own-vehicle position of a vehicle traveling on a road defined by a left-side road lane division line and a right-side road lane division line using an own-vehicle position estimation device includes steps of acquiring the first road lane division line information including the first left-side road lane division line information indicating the left-side road lane division line and the first right-side road lane division line information indicating the right-side road lane division line, the first left-side road lane division line and the first right-side road lane division line being detected by the imaging device mounted on the vehicle, acquiring the second road lane division line information including the second left-side road lane division line information indicating the left-side road lane division line and the second right-side road lane division line information indicating the right-side road lane division line, the second left-side road lane division line and the second right-side road lane division line being acquired by a method different from the detection method by the imaging device, determining a combination of the road lane division line information to be used for estimating the own-vehicle position on the basis of the first road lane division line information and the second road lane division line information, and estimating the own-vehicle position by correcting the second road lane division line information using the determined combination of the road lane division line information.

### Supplementary Note 11

The own-vehicle position estimation device according to Supplementary Note 10 is characterized in that the second road lane division line information is based on the map information.

Although various exemplary embodiments and examples are described in the present disclosure, various features, aspects, and functions described in one or more embodiments are not limited to an application in a particular embodiment, and can be applicable alone or in their various combinations to each embodiment.

Accordingly, countless variations that are not illustrated are envisaged within the scope of the art disclosed herein. For example, the case where at least one component is modified, added or omitted, and the case where at least one component is extracted and combined with a component in another embodiment are included.

### DESCRIPTION OF THE REFERENCE CHARACTERS

10: vehicle, 20: lane, 21: first left-side road lane division line, 22: first right-side road lane division line, 23: second left-side road lane division line, 24: second right-side road lane division line, 25: first point group data, 25a: first left-side point group data, 25b: first right-side point group data, 26: second point group data, 26a: second left-side point group data, 26b: second right-side point group data, 27a: second left-side corrected point group data, 27b: second right-side corrected point group data, 30a, 31a: centroid position, 90: camera, 91: locator, 100, 150: own-vehicle position estimation device, 101: first road lane division line information acquisition unit, 102: second road lane division line information acquisition unit, 103: road lane division line information determination unit, 104: own-vehicle position estimation unit, 110: correction amount calculation unit, 200: traveling route generation device, 300: vehicle control device, 500: vehicle control system, 530: actuator, 531: electronic power steering (EPS) controller, 532: powertrain controller, 533: brake controller, 535: EPS unit, 536: powertrain unit, 537: brake unit, 800: processing circuit, 801: processor, 802: memory, 803: storage medium, 804: program

What is claimed is:

1. An own-vehicle position estimation device for estimating an own-vehicle position of a vehicle traveling on a road defined by a left-side road lane division line and a right-side road lane division line, the own-vehicle position estimation device comprising at least one processor configured to implement:
a first road lane division line information acquisition circuitry to acquire first road lane division line information including first left-side road lane division line information indicating a left-side road lane division line and first right-side road lane division line information indicating a right-side road lane division line, the first left-side road lane division line and the first right-side road lane division line being detected by an imaging device mounted on the vehicle;
a second road lane division line information acquisition circuitry to acquire second road lane division line information including second left-side road lane division line information indicating the left-side road lane division line and second right-side road lane division line information indicating the right-side road lane division line, the second left-side road lane division line and the second right-side road lane division line being acquired by a method different from the detection method by the imaging device;
a road lane division line information determinator to determine a combination of road lane division line information to be used for estimating the own-vehicle position on a basis of the first road lane division line information and the second road lane division line information; and
an own-vehicle position estimator to estimate the own-vehicle position by correcting the second road lane division line information using the combination of the road lane division line information determined by the road lane division line information determinator.

2. The own-vehicle position estimation device according to claim 1, wherein the road lane division line information determinator determines the combination of the road lane division line information to be used for estimating the own-vehicle position on a basis of at least one of a deviation between the first left-side road lane division line information and the second left-side road lane division line information regarding left-side road lane division line information and a deviation between the first right-side road lane division line information and the second right-side road lane division line information regarding right-side road lane division line information.

3. The own-vehicle position estimation device according to claim 2, wherein
the first road lane division line information acquisition circuitry acquires, as the first road lane division line information, first point group data including first left-side point group data and first right-side point group data,
the second road lane division line information acquisition circuitry acquires, as the second road lane division line information, second point group data including second left-side point group data and second right-side point group data, and
the deviation is calculated using at least one of a point-to-point distance of points corresponding to each other among points of the first left-side point group data and points of the second left-side point group data and a point-to-point distance of points among points of the first right-side point group data and points of the second right-side point group data.

4. The own-vehicle position estimation device according to claim 2, wherein
the first road lane division line information acquisition circuitry acquires, as the first road lane division line information, first point group data including first left-side point group data and first right-side point group data,
the second road lane division line information acquisition circuitry acquires, as the second road lane division line information, second point group data including second left-side point group data and second right-side point group data, and
the deviation is calculated using at least one of a point-to-point distance of points corresponding to each other among points of the first left-side point group data and points of the second left-side point group data in a case where a centroid position of the points of the first left-side point group data and a centroid position of the points of the second left-side point group data are matched and a point-to-point distance of points among points of the first right-side point group data and points of the second right-side point group data in a case where a centroid position of the points of the first right-side point group data and a centroid position of the points of the second right-side point group data are matched.

5. The own-vehicle position estimation device according to claim 1, further comprising:
a correction amount calculator to calculate at least two or more correction amounts among a first correction amount calculated in a case where a combination of the first left-side road lane division line information, the first right-side road lane division line information, the second left-side road lane division line information, and the second right-side road lane division line information is used, a second correction amount calculated in a case where a combination of the first left-side road lane division line information and the second left-side road lane division line information is used, and a third correction amount calculated in a case where a combination of the first right-side road lane division line information and the second right-side road lane division line information is used, wherein
the road lane division line information determinator determines a combination of road lane division line information to be used for estimating the own-vehicle position on a basis of the two or more correction amounts calculated by the correction amount calculator.

6. The own-vehicle position estimation device according to claim 5, wherein
the correction amount calculator calculates at least one or more of a correction angle in rotation processing and a translation amount in translation processing as the first correction amount, the second correction amount, and the third correction amount, and
the own-vehicle position estimator estimates the own-vehicle position through a correction by performing the rotation processing and the translation processing with respect to second point group data included in the second road lane division line information acquired by the second road lane division line information acquisition circuitry.

7. The own-vehicle position estimation device according to claim 1, wherein
the first road lane division line information acquisition circuitry further acquires a first road lane division line information reliability to be an index of a reliability for the first road lane division line information,
the second road lane division line information acquisition circuitry further acquires a second road lane division line information reliability to be an index of a reliability for the second road lane division line information, and
the road lane division line information determinator determines a combination of road lane division line information to be used for estimating the own-vehicle position using at least one of the first road lane division line information reliability and the second road lane division line information reliability.

8. The own-vehicle position estimation device according to claim 1, wherein the second road lane division line information is based on map information.

9. A vehicle control system comprising:
the own-vehicle position estimation device according to claim 1 to estimate an own-vehicle position on a basis of road lane division line information;
a traveling route generation device to generate a traveling route for the vehicle that reaches up to a target point on a basis of the own-vehicle position, using the own-vehicle position output from the own-vehicle position estimation device; and
a vehicle control device to set a target trajectory and a target speed to be used for performing vehicle control of the vehicle on the generated traveling route.

10. An own-vehicle position estimation method for estimating an own-vehicle position of a vehicle traveling on a road defined by a left-side road lane division line and a right-side road lane division line using an own-vehicle position estimation device, the own-vehicle position estimation method comprising steps of:
acquiring first road lane division line information including first left-side road lane division line information indicating a left-side road lane division line and first right-side road lane division line information indicating a right-side road lane division line, the first left-side road lane division line and the first right-side road lane division line being detected by an imaging device mounted on the vehicle;
acquiring second road lane division line information including second left-side road lane division line information indicating the left-side road lane division line and second right-side road lane division line information indicating the right-side road lane division line, the second left-side road lane division line and the second right-side road lane division line being acquired by a method different from the detection method by the imaging device;
determining a combination of road lane division line information to be used for estimating the own-vehicle position on a basis of the first road lane division line information and the second road lane division line information; and
estimating the own-vehicle position by correcting the second road lane division line information using the determined combination of the road lane division line information.

11. The own-vehicle position estimation device according to claim 10, wherein the second road lane division line information is based on map information.
